(19) United States
(12) Patent Application Publication
(10) Pub. No.: US 2014/0305541 A1
(43) Pub. Date: Oct. 16, 2014

(54) Container Filling Valve

(71) Applicant: Richard D. Jenne, Willowick, OH (US)

(72) Inventor: Richard D. Jenne, Willowick, OH (US)

(21) Appl. No.: 14/317,990

(22) Filed: Jun. 27, 2014

Related U.S. Application Data
(63) Continuation-in-part of application No. 13/942,110, filed on Jul. 15, 2013.
Application No. 13/942,110 is a continuation-in-part of application No. 13/941,992, filed on Jul. 15, 2013.
Application No. 13/941,992 is a continuation-in-part of application No. 12/834,886, filed on Jul. 12, 2010, now Pat. No. 8,496,031.
Application No. 12/834,886 is a continuation-in-part of application No. 11/779,987, filed on Jul. 19, 2007, now Pat. No. 7,753,093.
(60) Provisional application No. 61/978,684, filed on Apr. 11, 2014.
(60) Provisional application No. 60/836,499, filed on Aug. 9, 2006.

(51) Int. Cl. B67C 3/06

(52) U.S. Cl. CPC B67C 3/06
USPC 141/6; 141/46

(57) ABSTRACT

A fluid filling valve that dispensed fluid to a container in a swirl fashion providing smoother fills with less foam to enable fluids to be dispensed at higher temperatures than conventional filling valves.

### CROSS-REFERENCES TO RELATED APPLICATIONS

This application claims the benefit of provisional patent 61978684, filed Apr. 14, 2014, and is a continuation in part of patent application Ser. Nos. 13/941,992 and 13/942,110, each filed Jul. 15, 2013, which are continuations in part of U.S. Patent Application 12/834,886 filed Jul. 12, 2010, which issued on Jul. 30, 2013 as U.S. Pat. No. 8,496,031, which is a continuation in part of U.S. patent application Ser. No. 11/779,987, filed Jul. 19, 2007, which issued on Jul. 13, 2010 as U.S. Pat. No. 7,753,093, which claims the benefit of U.S. Provisional Application 60/826,499, filed Sep. 21, 2006; the disclosures of each of which are incorporated herein by reference.

### TECHNICAL FIELD

In automatic beverage filling machines, the invention relates to the filling valves associated with such machines to allow for smoother, more accurate and higher speed filling processes at higher temperatures.

### BACKGROUND

Beverage cans may be filled by automated container filling systems, wherein an empty can or other container is engaged with a filling valve and the beverage dispenses from the filling valve into the container. One automated container filling system provides counter pressure filling, in which the container is filled with pressurized gas before the beverage is dispensed. In other counter pressure filling systems, a filling valve includes a seal that expands against the top of the container, thereby sealing the inside of the container for receiving pressurized gas.

Generally, in the filling process, a plurality of containers move through a rotary filler at high speeds. Empty containers are presented to the filling valve as the rotary filler turns. After the filling valve fills the container, it moves off of the rotary filler.

In filling valves associated with known machines, various deficiencies are found to effective and fast filling procedures. One problem noted with known valves relates to the liquid seal within the valve, which has a wedge-shaped sealing surface that contacts a wedge seal seat, wherein the liquid seal has the tendency to be frictionally engaged in a manner that causes hesitation when opening the valve, thereby causing a short fill.

Existing components of filling valves, such as the nozzle and riser tube, are typically integral and not removable, so they are not easily replaced if damaged. Existing designs cause additional man hours to change components and mandate line down time. Existing parts endure considerable loads and wear out easily. Existing designs can break and contaminate the product with metal shavings or parts. Existing filling valves are constructed with seams that could harbor bacteria or mold.

Other delays in the filling process are found in the need to sniff a significant volume of gas upon completion of the fill from the headspace in the valve. Loss of liquid contents also could occur by the liquid entering the space around a can sealing member during the fill process, and being retained in association with the valve behind the can sealing member.

Additional problems with known valves are found in the manner in which liquid is directed into the can or other container. With a can, known valves introduce the liquid well below the top of the can. This can cause splashing, agitation of product, and bubbles in the flow of the liquid into the container as the fill height increases.

Another problem with existing valves has been their ability to fill containers in a manner to reduce foaming or for filling containers of differing sizes. For example, as it is desired to fill the container as quickly as possible, introduction of the liquid is performed with the valve fully opened, which can produce excessive foaming. Further, a valve for filling a small can may cause foaming and/or excessive fill times when used for filling a large can and vice versa. This causes lost product, inaccurate filling, or lost production due to change-over from one valve to another to accommodate various sized containers. Other problems, including limitations to proper cleaning of such valves, have been noted.

An additional problem with prior valves is being able to fill at warmer temperatures. The industry standard is to run a can filler from about 36° F.-38° F. to control foaming. Filling at chilled temperatures requires energy to chill and then reheat product. This energy consumption is inefficient and costly. Filling at cooler temperatures also increases oxygen (O2) levels in product. Higher O2 levels cause oxidation in the can lining, which causes the can to leak and shortens shelf life. Prior valves have attempted to fill at warmer temperatures, but that typically leads to a short fill. Typically, ball cage shims have to be removed to get the fill weights back into specification, which requires man hours and lost production time to install the necessary shims.

A need exists for a filling valve that provides a fast yet smoother fill with less entrapped gas bubbles in the product. A need exists for a valve to rapidly and accurately fill product to weight specifications. A need exists for a can filling valve that fills faster, cleaner, reduces waste, and allows for running at warmer temperatures. A need exists for a valve that does not allow the product to migrate behind the can seal, thereby wasting product. A need exists for a valve that eliminates hesitation on the valve opening to increase filling speed. A need exists for a valve with ability to change valve nozzle size or configuration to accommodate different sizes of containers. A need exists for a filling valve that has easily replaceable parts. A need exists for efficient cleaning-in-place (CIP) channeling and configuration. A need exists for a filling system that overcomes short fills by eliminating the centrifugal force that lifts the fluid up the inner container surfaces. A need exists for a valve comparable in speed to any other valve on the market that runs with less foam. A need exists for a valve that fills product at a warmer temperature than that of standard filling valves.

### SUMMARY OF THE DISCLOSURE

The present invention overcomes the shortcomings of existing devices by providing improvements including at least:
a. angled nozzle outlets that overcome the centrifugal force of a fill;
b. a flat liquid seal and sleeve centering device to eliminate hesitation on the valve opening;
c. the ability to change the nozzle size or configuration and replace parts, including, but not limited to the riser stem assembly and the ball cage;
d. a cleaning-in-place channeling (CIP) that eliminates a CIP button; and
e. a faster, cleaner, reduced-waste fill that runs warmer than traditional valves.

In the present invention, the liquid flow path contacts the can just under the short angled can wall extending upward from the necked down shoulder to the flange on the top of the can. With this design, the flow of liquid is contacting the outward tapered wall of the shoulder which causes a smoother directional change for the liquid.

In an embodiment, the unique nozzle design of the present invention causes the product to swirl in the can causing a much smoother fill and less entrapped gas bubbles in the product giving a much tighter fill weight over the industry standard tip-less valves. The can seal is fitted to the nozzle with a lip seal so product cannot get behind the seal, so, when filling at higher speeds, product is not thrown out of the bell at can transfer, thus improving syrup yields.

The present invention is a filling valve for filling a container with a fluid. The valve comprising a valve body, a nozzle, a riser tube, a counter pressure seal, a liquid seal, a container seal, a ball cage, and a snift valve. In an embodiment, the valve body has a chamber. The chamber floor is a substantially flat surface that includes apertures.

In an embodiment, the nozzle is releaseably attached to the chamber and in fluid communication with the chamber. The nozzle comprising a plurality of ports angled and oriented to direct fluid flowing from the chamber through the ports and into the container. The ports are angled and oriented such that the fluid enters the container at a first point of contact at a side wall of the container and the fluid swirls as it fills the container.

The riser tube is releaseably connected to the chamber at a floor of the chamber. the riser tube comprising a gas passageway from the ball cage to a space above fluid yet to be dispensed into the container.

The counter pressure seal is located at an end of the riser tube opposite the chamber floor. The counter pressure seal is connected to a spring. The spring absorbs load from the counter pressure seal when it seats to close the riser tube.

The liquid seal is substantially flat and located in the chamber near the floor of the chamber. The liquid seal is attached to a sleeve that rises to start the flow of fluid through the chamber aperture to the nozzle, and falls to cover the apertures. The liquid seal is centered over the apertures by a centering device attached to the sleeve.

The container seal is positioned around a peripheral surface of the nozzle and substantially prevents liquid from flowing into an area about the peripheral surface. The container seal comprises a seal cavity and is positioned for sealably engaging the container.

The ball cage is releaseably attached to the valve body though an opening in the nozzle. The ball cage is attached to the valve body by a male female thread connector of approximately 0.69 inches (with no shims added) and approximately 0.565 inches with the maximum of 0.125 inches of shim added to the connector. The ball cage comprises a moveable floatable ball and forms a gas passageway from the container to the riser tube.

The snift valve is in gas communication with the nozzle and the container seal.

When the gas pressure within the container equals the air pressure within the headspace of the reservoir containing liquid yet to be dispensed, a fluid valve spring lifts the liquid seal and fluid is allowed to flow from the chamber into the nozzle and into the container. As the container fills with liquid, the gas in the container returns back up through the ball cage passageway and riser tube passageway and back into the headspace of the reservoir. The ball floats in the liquid filling the container until it seats and stops the flow of gas from the container to the headspace of the reservoir. Liquid continues to flow into the container until the pressure above the liquid in the container is equal to the pressure in the headspace of the reservoir plus the inches of water column the liquid in the reservoir and valve body generate. At this point the flow of liquid is stopped. A fixed valve closer rotates a cam, moving the liquid seal to cover the housing apertures and seating the counter pressure seal at the riser tube to seal the riser tube passageway. When the snift valve is actuated, it brings the container back to atmospheric pressure and releases pressurized gas from the seal cavity and the container, causing the container seal to deflate and thereby disengage from the top interior walls of the container.

In an embodiment, the present invention further comprises a clean-in-place system to direct cleaning solution through the nozzle and into an interior of a bell surrounding the nozzle and ball cage. Actuating the snift valve causes cleaning solution to pass around an inside of the liquid seal. A hose directing the cleaning fluid is in fluid communication with the chamber.

In an embodiment, using the filling valve of the present invention fills a 12 oz carbonated beverage can with product in 1.74 seconds. Because the filling valve of the present invention introduces fluid into the container in a swirl fashion, the container can be filled at a temperature of greater than about 36° F. In an embodiment, containers are filled at a temperature of about 68° F.

As used herein, “approximately” means within plus or minus 25% of the term it qualifies. The term “about” means between ½ and 2 times the term it qualifies.

The compositions and methods of the present invention can comprise, consist of, or consist essentially of the essential elements and limitations of the invention described herein, as well as any additional or optional ingredients, components, or limitations described herein or otherwise useful in compositions and methods of the general type as described herein.

Numerical ranges as used herein are intended to include every number and subset of numbers contained within that range, whether specifically disclosed or not. Further, these numerical ranges should be construed as providing support for a claim directed to any number or subset of numbers in that range or to be limited to the exact conversion to a different measuring system, such, but not limited to, as between inches and millimeters.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

Terms such as “top,” “bottom,” “right,” “left,” “above”, “under”, “side” “front”, “below” “upper”, “back” and the like, are words of convenience and are not to be construed as limiting.

### BRIEF DESCRIPTION OF THE DRAWINGS

FIG. 1 is an exploded view of an embodiment of the filling valve.

FIG. 2 is a top perspective view of an embodiment of the filling valve.

FIG. 3A is a side view of an embodiment of a nozzle.

FIG. 3B is a cross-sectional 3D side view of an embodiment of a nozzle.

FIG. 3C is a cross-sectional 3D side view of an embodiment of a container seal.

FIG. 4 is an exploded view of an embodiment of a ball cage assembly of the filling valve.

FIG. 5 is an exploded see-through view of an embodiment of a snift valve of the filling valve.

FIG. 6 is a cross sectional view of an embodiment of the filling valve.

FIG. 7 is a top view of a container centering element.

FIG. 8 is a partial see-though view of an embodiment of a bell.

### DETAILED DESCRIPTION OF THE DRAWINGS

The disclosure is directed to an improved filling valve having replaceable components that fills different sized containers with a fluid. The fill is faster, with less foaming and at higher temperatures than that of conventional filling valves. The improved filling valve is generally functionally related to filling valves in widely used and long known filling machines, including but not limited to filling machines known as Crown filler machines.

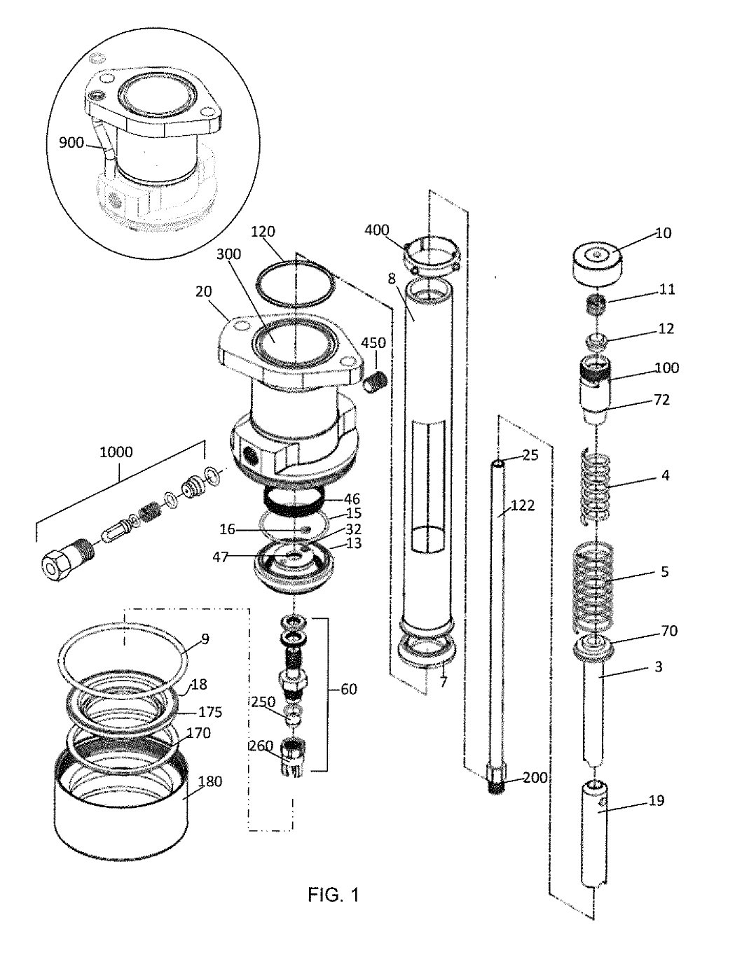

As shown in FIG. 1, the filling valve comprises a generally cylindrical housing 20 having a chamber 300. A nozzle assembly 13 is attached to the housing and includes a nozzle O-ring 15 and snift O-ring 16. The chamber 300 is in fluid communication with the nozzle assembly 13.

In an embodiment, a removeable ball cage assembly 60 is connected to the nozzle 13 and the housing 20. The nozzle 13 has a central opening 47 for passage of a connecting end of the ball cage assembly 60 through the nozzle to allow for fastening of the ball cage assembly 60 and the nozzle 13 to the housing 20. The nozzle 13 is held in place by the ball cage assembly, so if damaged, it is replaceable. A bell 180 is removeably attachable to the housing 20. The bell 180 encircles the nozzle 13 and the ball cage assembly 60. The bell comprises a bell O-ring 9, a container seal 18 and a container seal ring 170. The container seal ring is preferably formed from a metal, such as stainless steel and prevents rotational slip when a container is on the valve. A groove in the bottom of the housing 20 mates with or positively engages O-ring 175 molded into the seal 18 to keep the container seal 18 from egg-shaping when tightening the bell. O-ring 9 has a larger cross section that does not peal out as the bell is tightened to the housing.

In the embodiment depicted in FIG. 1, a snift valve assembly 1000 is connected to the housing 20. The snift valve assembly 1000 is in communication with the nozzle 13 and a snift O-ring 16.

As depicted in FIG. 1, the filling valve further comprises a liquid seal 7 at a bottom end of the sleeve 8 and sleeve centering device 400. The sleeve centering device 400 encircles the diameter of the sleeve at a point within the chamber 300 of the housing and keeps the sleeve in the center of the chamber, especially when the valve is opened.

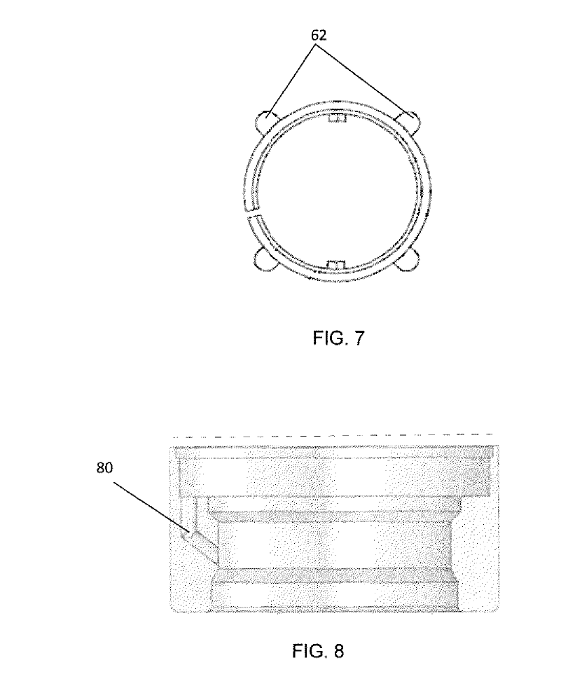

As seen in FIG. 7, the sleeve centering device 400 comprises at least one boss 62 for guiding the sleeve 8 in the chamber 300. In an embodiment, the sleeve centering device 400 comprises a plurality of bosses 62 situated at 90 degree spacing around the sleeve centering device 400 that center the sleeve within the chamber by contact with a side wall of the chamber. The bosses 62 may be integrally formed or separately attached. Other configurations to center the sleeve 8 without undue restriction to the movement are contemplated.

The sleeve centering device 400 insures the liquid seal 7 covers the aperture 52 for liquid porting in the valve body. The centering device provides the advantage of providing no hesitation on valve opening even if the liquid seal swells up over time. The flat liquid seal and sleeve centering device do not interfere with the speed of the fill during the opening of the liquid seal.

In an embodiment, the filling valve comprises a counter pressure body 100, a counter pressure seal 12, a counter pressure seal spring 11 and a counter pressure cap 10. The counter pressure body 100 comprises, at one end, an upper charge spring seat 72. The upper charge spring seat 72 engages a charge valve spring 4. An upper fluid spring seat 78 located in the sleeve 8 engages a fluid valve spring 5. The opposite ends of each of the valve spring 4 the fluid valve spring 5 engage a lower spring seat 70.

In an embodiment, the lower spring seat 70 is coupled to a valve sleeve guide 3 positioned to engage a spacer 19. A drainage hole may be provided in spacer 19. The spacer 19 is axially positioned to sheath a riser tube 122. The riser tube 122 forms a riser passageway 25 and is connected to the housing 20 by a riser tube connector 200. The valve sleeve guide 3 and spacer 19 and springs 4, 5, counter pressure body 100, counter pressure seal spring 11 and counter pressure seal 12, are axially positioned within the sleeve assembly. The spacer 19 supports the valve sleeve guide 3, which supports springs 4 and 5.

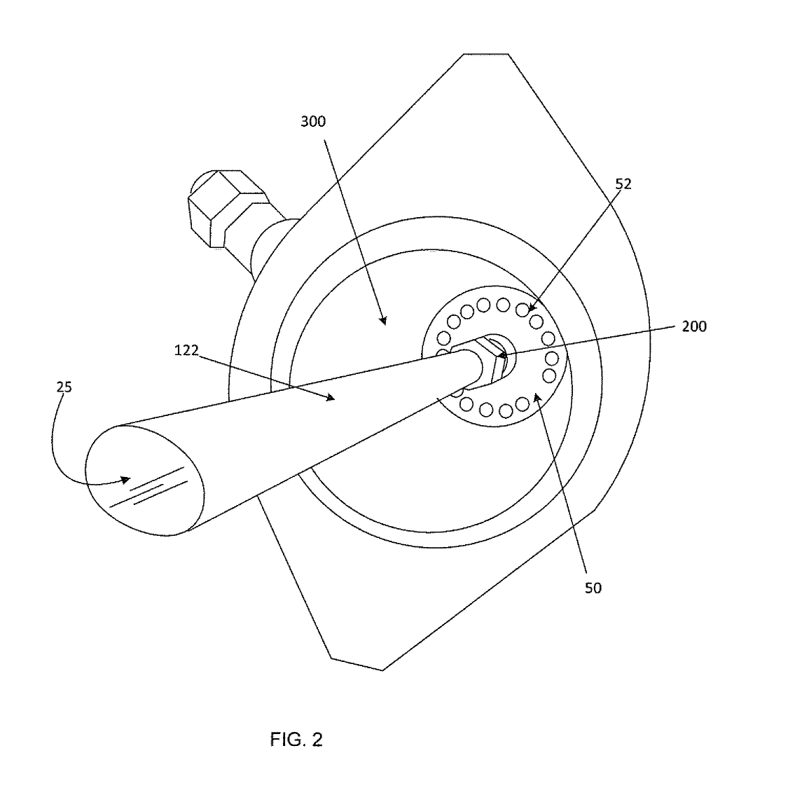

As shown in FIG. 2, the bottom of the chamber 300 comprises a substantially flat surface 50 and at least one housing aperture 52 for fluid flow from the chamber 300. The liquid seal 7 engages flat surface 50. When lifted off its seat by spring 5, the liquid flows through the at least one housing aperture 52 to the nozzle assembly 13. The liquid seal 7 comprises a flexible and resilient material suitable for preventing pressurized liquid from passing between the liquid seal 7 and surface 50.

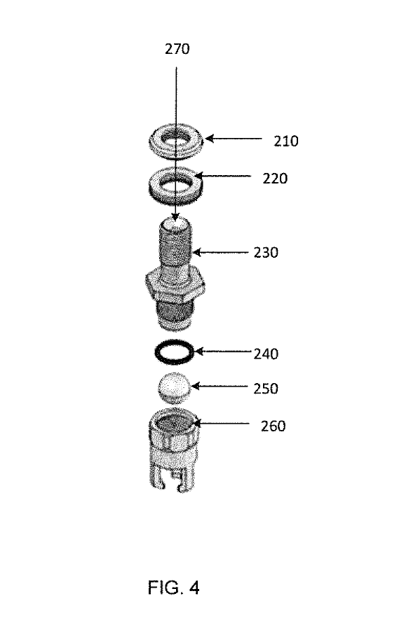

In an embodiment, the riser tube 122 extends from within the chamber 300. The riser tube 122 is releasably connected to the flat surface 50 of the chamber 300 by the riser tube connector 200. The connector 200 is any suitable secure detachably attachable connection, such as a screw engagement. The connector 200 connects the riser passageway 25 to the ball cage assembly passageway 270 (FIG. 4). The riser passageway 25 is positioned within the riser tube 122. The riser passageway 25 and the ball cage passageway 270 provide a passageway from the container to the reservoir and extends above the fluid level in the reservoir into a pressurized gas.

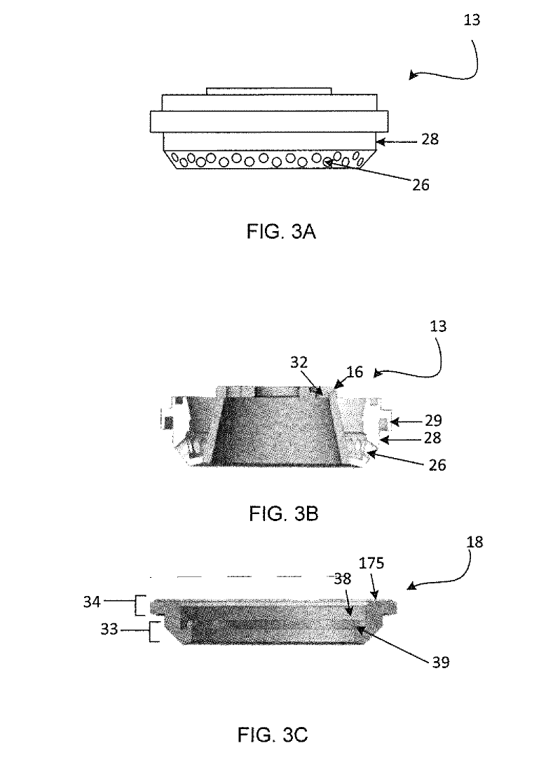

As depicted in FIG. 3A and FIG. 3B, the nozzle assembly 13 comprises at least one dispensing outlet 26 and a peripheral surface 28. In an embodiment, the outlets are arranged about a central axis. The outlets 26 are oriented to dispense fluid in a downwardly direction defined by an outward angle, and possibly a tilt angle. In an embodiment, the outward angle is an angle from a transverse plane perpendicular to the central axis of the nozzle 13. The outward angle directs fluid against an inner wall of the container during the filling operation. In an embodiment, the outward angle is within a range of approximately 30° to 70° from the transverse plane. In another embodiment, the outward angle is from approximately 50° to approximately 54° from the transverse plane. The outward angle may be selected to cooperate with the container being filled to decrease the amount of turbulent flow and increase the amount of laminar flow. The angled nozzle outlets overcome the centrifugal force of a fill.

Some containers, such as certain beverage cans, have a lip or ridge near the mouth of the container. When filling containers with a lip or ridge, the outward angle of the nozzle outlet 26 may be selected to direct the flow of fluid against the inner wall of the container at a location beneath the lip or ridge. In an embodiment, the present invention liquid flow path contacts a container such as a beverage can, just under the short vertical can wall extending upward from the necked down shoulder to the flange on the top of the can. Other nozzles allows the stream from the nozzle to contact the short vertical wall which is a more abrupt hit that causes splashing, agitation of product, and foaming. The liquid flow of the present invention contacts the outward tapered wall of the shoulder of the can, which causes a smoother directional change for the liquid.

The tilt angle is an angle from a radial plane parallel to the central axis of the nozzle 13. The tilt angle directs fluid in a swirling direction during the filling operation of a cylindrical, spherical, or otherwise rounded container. In an embodiment, the tilt angle is within a range of approximately 10° to 40° from the radial plane. In an alternate embodiment, the tilt angle is approximately 36°-37° from the radial plane. It is contemplated that the tilt angle may be selected to cooperate with the container being filled to decrease the amount of turbulent flow and increase the amount of laminar flow. The ability to provide laminar flow directed in a predetermined manner for any particular container allows for faster fill times (1.74 seconds or less), without having the liquid escape from the container due to the centrifugal force of a rotary filler. The nozzle outlets 26 cause dispensed fluid to swirl in the container causing a much smoother fill and less entrapped gas bubbles in the fluid giving a tighter fill weight than existing tipless valves.

When the product issues from the nozzle, the liquid swirls into the container. The swirling motion has several benefits. Rather than the conventional valve starting the flow of product in a downward direction which causes more velocity of the product when it reaches the bottom of the container, the swirl flow path starts off more horizontally and gravity pulls it downward. Slowing the product velocity down causes less turbulence when the liquid reaches the bottom of the container. In the faster running fillers, centrifugal force on the product in the container causes the liquid level in the container to raise up on the outboard side of the rotary filler. The swirling action of the nozzle helps overcome the force caused by the centrifugal force of the filler, thus keeping the product flatter in the container and insuring more accurate fill weights.

In an embodiment, the outlet 26 is designed to enable a volume of liquid to pass therethrough in a predetermined period of time. In an embodiment, each outlet 26 has a diameter of approximately 0.15 to 0.20 inches. In an alternate embodiment, each outlet 26 has a diameter of approximately 0.08 to 0.15 inches. Other nozzle embodiments are contemplated, such as an outlet opening diameter of between about 0.002 to 0.006 inches. It is contemplated that the nozzle 13 may comprise any suitable number of outlets for dispensing fluid into the container.

In an embodiment, a screen 46 (FIG. 1) may be positioned between the chamber 300 and the outlet 26. In an embodiment, the screen 46 is vertically positioned inside the nozzle to be protected from ambient air and thus is maintained in the relatively acidic environment of the liquid and maintains cleanliness of the screen 46. In an embodiment, the screen comprises a substantially cylindrical shape, positioned coaxially within the nozzle. In an embodiment, the screen is between 20 and 40 mesh. It is contemplated that the screen configuration may have a mesh size larger or smaller to accommodate the liquid being dispensed. The screen 46 provides surface tension characteristics to restrict gas passage from the container to the reservoir when the filling cycle is complete but while the valve is still open, and facilitates preventing flow of liquid when the valve is in the valve-closed position. The screen in the nozzle sets up surface tension to restrict gas from the head space of the container from migrating back into the head space of the reservoir, to avoid a flood fill. The position of the screen 46 is also as low in the valve as possible—almost at the height of liquid in a container upon a completed fill. This positioning provides less delay at the end of a fill cycle when a ball valve 250 in the ball cage assembly 60 (FIG. 1) rises to block air flow from the container through the passageway 270, 25 as the liquid height reaches the fill height. The position of the screen 46 eliminates delay for the last of the liquid product to enter the container. This positioning also allows for a closer tolerance on the actual fill height of the container. In an alternate embodiment, a screenless nozzle may be used for thicker liquids or pulp products.

In an embodiment, the nozzle 13 is removeably connected to the housing 20 to allow a user to change out the nozzle for a different size container or replace the nozzle. The nozzle is attached to the housing below the chamber at an operative end of the housing for directing fluid into a container. In an embodiment, the container is presented so that a mouth or opening of the container is beneath the nozzle 13. The container is centered under the nozzle 13 by bell 180.

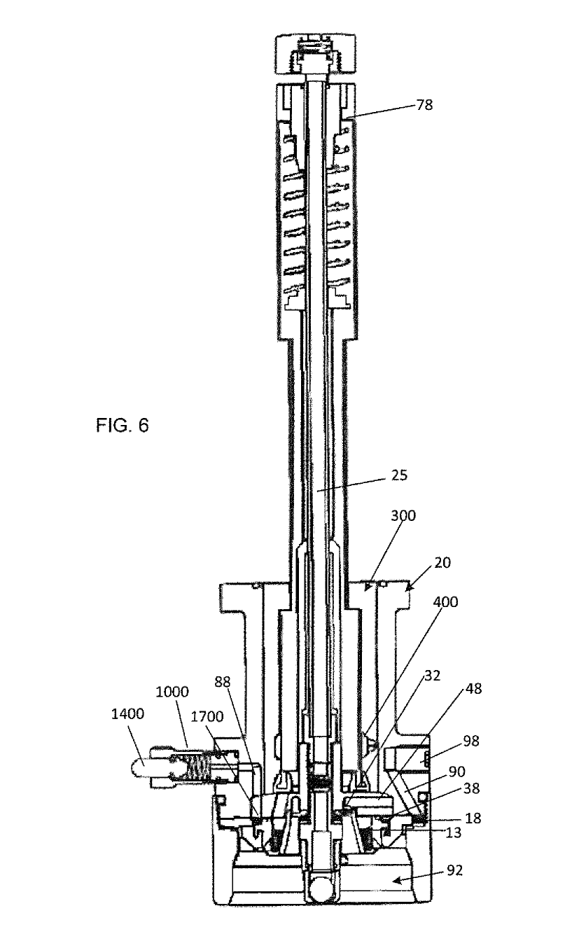

The bell 180 is capable of surrounding the opening of the container when the container is in the filling position. The bell 180 may have a substantially cylindrical shape having an inner area 92 (FIG. 6) surrounding the nozzle 13, and a lower opening through which the container is positioned. The bell 180 attaches to the housing 20 by any secured means, such as male and female threads.

In an embodiment, the nozzle peripheral surface 28 has a cylindrical shape configured to mate with the container seal 18. The container seal 18 is operably positioned around the peripheral surface 28 in close relationship and without interruption. Referring to FIG. 3C, at least one O-ring 175 may be molded into the container seal 18. The O-ring 175 corresponds to a groove (not shown) in the bottom of the housing 20. The container seal 18 further comprises a lip seal 39 that mates with nozzle lip 29 on the nozzle so fluid cannot get behind the seal. This configuration allows filling at higher speeds without fluid loss due to being ejected after the container is moved from the valve, Eliminating product ejection saves at least about 3.3 ounces per minute over standard can filling, thus improving syrup yields. In an embodiment, the container seal has O-ring 175 molded in the top side of a flange of the container seal 18.

The container seal 18, has a substantially uniform cross section, and is positioned such that when the container seal 18 is installed on the nozzle, the seal has a can sealing portion 33 and a valve sealing portion 34 to seal the nozzle peripheral surface 28 to substantially prevent flow of any liquids past the seal. The discontinuities in past sealing members enabled liquid to flow past and into a cavity 38 . The configuration of the container seal 18 prevents migration and retention of such liquid to the space or cavity 38, which may otherwise be subsequently improperly released to result in waste of any retained product. In this embodiment, the container seal 18 does not include any notches or other structures to allow flow of pressurizing gasses as in the prior art, but instead seals against the outside bottom surface of the housing 20. The seal has a size for sealably engaging the inner walls of the container. In an embodiment, the container seal 18 comprises a flexible and resilient material suitable for preventing pressurized liquid from passing between the container seal 18 and the nozzle.

The seal 18 is interchangeable for different sized containers, replaceable and may be made from a flexible and resilient material such as, but not limited to, a thermoplastic elastomer or rubber. The seal 18 comprises a shape such that at least a portion of the seal flexes or expands when the space behind the seal, or the seal cavity 38, is filled with pressurizing gas, causing further engagement of the container sealing surface 33 with the inner walls of the container. The seal is capable of sealing against the container when in the expanded or flexed position, thereby sealing the nozzle in the mouth or opening of the empty container and holding the pressurizing gas in the container at a selected pressure. When the pressurizing gas in the seal cavity 38 is released, the seal returns to its original shape and position.

Referring to FIG. 4, the ball cage assembly comprises shim retainer 210, at least one ball cage shim 220, a ball cage connector 230, a ball cage O-ring 240, a ball 250 and a ball cage 260. The ball cage height is adjustable by adding or removing ball cage shims 220 so that the fluid fill height may be varied. The fill height is simply adjusted by adding or removing shims. A retainer 210 provides that the shims are not lost or left stuck on the nozzle surface when the ball cage assembly 60 is removed. The ball cage connector 230 has threads that screw into the housing 20. The threads are longer than prior connectors so that the ball cage is more durable. A ball cage becoming fully unscrewed is less likely to occur due to the longer threads. Should a ball cage start to loosen, the longer threads extent the ball cage 260 so that it contacts the side of the container at the infeed so that the container is rejected prior to the seamer. Longer threads reduce the possibility of a ball cage falling off into a container.

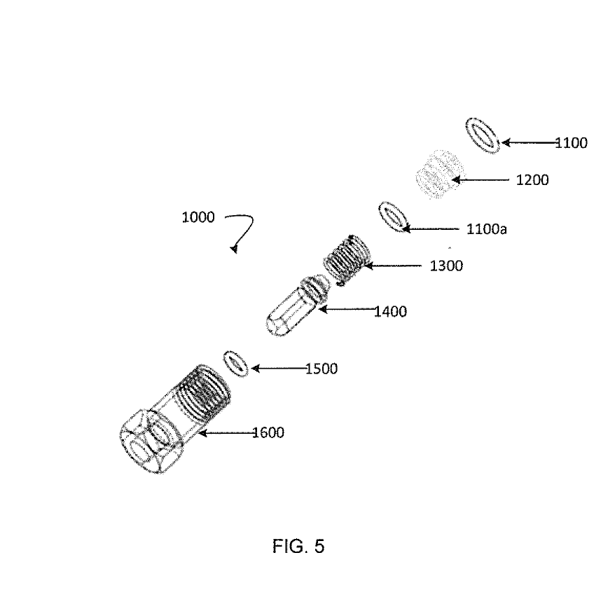

Referring to FIG. 5, in an embodiment, the filling valve comprises a snift valve assembly 1000. The snift valve assembly comprises snift valve plug O-rings 1100, 1100a, a snift plug 1200, a sniff plunger spring 1300, a snift plunger 1400, a sniff valve body O-ring 1500, and a snift valve body 1600. As depicted in FIG. 3C, FIG. 3B and FIG. 6, the sniff valve assembly 1000 is in communication with a seal cavity 38 and port 32 to release pressurized gas from the seal cavity 38 and the container thereby causing the container seal 18 to deflate and disengage the top interior walls of the container.

The valve body and bell threads are both treated with a friction reducing process that prevents thread galling. The valve body is constructed void of all seams that could harbor bacteria or mold. All stainless components are 316 stainless and the plastic parts and rubber goods are FDA approved material compatible with CIP chemicals and temperatures.

In operation, the filling valve operates between a valve-open position and a valve-closed position. Referring now to FIG. 6, the reservoir (not shown) is positioned vertically above the housing 20 such that the reservoir is in fluid communication with the chamber 300, so that a liquid beverage or other fluid selectively flows from the reservoir to the chamber 300 in the housing. An O-ring 120 is used in the connection to the reservoir.

To open the valve, the counter pressure cap 10 is lifted by any typical mechanism, such as a cam, lever, switch, etc., against which the counter pressure cap 10 moves from a lower to an upper position. In an embodiment, spring 4 expands and lifts the counter pressure cap 10 when a valve cam positioned on the top of the cap rotates from a closed to an open position. When the counter pressure cap 10 moves to the upper position, the compressed spring 4 expands, lifting the counter pressure seal 12 and opening the passageway 270, 25.

Upon engagement with a container, pressurizing gas from the passageway 270, 25 flows through the ball cage assembly 60 and into the container causing the container seal 18 to expand and engage the top interior walls of the container. Port 48 creates a gas passageway connecting the seal cavity 38 with nozzle aperture 32 for communicating pressurizing gas from the passageway 270, 25 through the nozzle aperture 32 into the seal cavity 38 for expanding the container seal 18. Gas flows from nozzle aperture 32 to a cavity 38 causing the container seal 18 to expand into sealing engagement with the container positioned on the valve. The seal 18 provides sufficient engagement with the container to allow additional pressurizing gas to be released into the container to achieve a pressure inside the container greater than 1 atmosphere.

Once the pressure in the container substantially equals the pressure in the reservoir, the fluid valve spring 5 lifts the sleeve 8, which lifts the liquid seal 7 from the flat surface 50. Liquid starts flowing into the chamber 300, through apertures 52, through the nozzle 13 and out nozzle outlets 26.

As the fluid level rises in the container, the pressurizing gas in the container is forced back through the passageway 270, 25 and into the headspace of the reservoir containing liquid yet to be dispensed. The ball 250 floats in the liquid filling the container until it seats and stops the flow of gas from the container to the headspace of the reservoir. Liquid continues to flow into the container until the pressure above the liquid in the container is equal to the pressure in the headspace of the reservoir plus the inches of water column the liquid in the reservoir and valve body generate. At this point the flow of liquid is stopped. A fixed valve closer rotates a cam, moving the liquid seal to cover the housing apertures and seating the counter pressure seal at the riser tube to seal the riser tube passageway. The snift assembly is actuated bringing the container back to atmospheric pressure.

Using the present invention, a 12 ounce soda can fills in 1.74 seconds without excess foaming. Importantly, other filling valves do not control the bubbles in the product introduced into the container. Bubbles displace liquid and cause the ball to lift prematurely. The present invention creates a uniform laminar flow of product on the interior wall of the container, thus reducing bubbles in the product and providing more consistent fills of products in the container.

The cap 10 is mechanically pushed down to close the valve. As the counter pressure cap 10 moves to the lower position, the cap pushes the upper charge spring seat 72 downward, thus compressing the fluid valve spring 5. The counter pressure seal spring 11 absorbs any excess travel of the counter pressure cap 10 when the valve is in the closed position. The spring 11 insures the sealing off of gases once the riser tube 122 is closed by counter pressure seal 12. The spring 11 above the counter pressure seal assures a positive seal. Leaking of this seal in other filling valves causes foaming, which creates low fill weights and product out of specifications. Removing the load also greatly extends the life of the counter pressure seal and assures that no gas can seep into product during the snift, which is a common problem in the standard valves of in the industry.

When the cap is in the lowered position, the cap causes the fluid valve spring 5, the charge valve spring 4, and the counter pressure seal spring 11 to be compressed. The riser passageway 25 is sealed by the lowering of the counter pressure seal 12.

In an alternative embodiment, the filling valve may provide a variable flow rate through the valve as desired as the valve operates between the valve-closed and valve-open positions.

When the container is filled to a desired level with fluid, pressurizing gas remains in the container above the fluid. The snift valve 1000 is actuated causing the pressurized gas in the container to vent, returning the container to atmospheric pressure. The head space in housing 20 where gas remains after filling is reduced such that the volume of gas required to be sniffed is smaller, thereby allowing faster operation.

Referring to FIG. 6, during the sniff process, the top of riser passageway 25 is sealed and snift valve button 1400 of snift valve assembly 1000 is depressed. Port 88 communicates between snift valve assembly 1000 and the can seal cavity 38, the can head space and passageway 270, 25, to bring the filling pressure required back to atmospheric pressure.

The bulkiness of the nozzle takes up head space in the container so there is less gas to snift off. This allows for a smaller diameter of the snift orifice 1700 which is gentler on the product. The present invention valve is comparable in speed to any other valve on the market and runs with less foam. As it is desired to avoid fluid loss through the snift valve, in an embodiment, the port 48 is positioned away from the fluid in the container to eliminate the possibility of fluid entering the port 32. The port 48 is positioned inside the nozzle 13, and may be higher than the sealing member 18, without interrupting the seal between the nozzle 13 and the sealing member 18.

When the liquid in the container reaches the desired fill, the platform with the container is lowered and the container is discharged off the valve.

In an embodiment the fill valve has a clean-in-place (CIP) system associated with housing 20. A passageway 90 is formed in the housing 20. In one embodiment, the filling valve may be cleaned by filling the reservoir with a cleaning fluid and circulating the cleaning fluid through the filling valve. In one cleaning method, a cleaning cup is positioned to sealably engage a lower portion of the bell 180. In this embodiment, a cleaning fluid conduit is affixed between passageway 90 to direct cleaning solution out of outlet 98 to a remote recirculating pump and back to the reservoir. When the filling valve is opened, cleaning fluid flows out of the reservoir, through the nozzle 13 and into the bell inner area 92, then through passageway 90, and outlet 98 to a remote recirculating pump and back to the reservoir. In one cleaning method embodiment, the cleaning fluid is circulated at an elevated temperature. The cleaning fluid may be maintained in a temperature range of approximately 185-190° F. (approximately 85-88° C.). In one method embodiment, the fluid circulates for approximately 20 minutes. In this embodiment, the CIP system provides more uniform and thorough cleaning of the valve surfaces. The CIP discharge port 98 is routed through the centering bell 180 and into the CIP port in the valve body where it is sent to the main return line. As the snift actuator 99 is operated during cleaning, the CIP solution is made to pass around the inside of the liquid seal 7 to clean these surfaces. This arrangement eliminates a CIP button on a two button valve, which may allow leakage past the valve when associated O-rings wear cause a low fill/no fill container on that valve.

Actuating the snift actuator 99 during cleaning allows drainage from the CIP piping to drip into a container under the valve. The present invention allows the CIP solution to enter into a port drilled into the upper interior portion of the bell (away from the can opening) to flow into a channel. A second port connected to passageway 90. Outlet 98 comprises a hose fitting 450 which allows the CIP solution to be returned back to the CIP reservoir where it is reheated and returned to the filler.

The CIP porting of the present invention is unique in that it allows attachment of a CIP hose to the valve body for the single button style valve instead of having the hose on the CIP cup (which has to be hooked up for every CIP). The CIP system ports the CIP solution back through the chamber 300 so that no CIP button is required. The bell is ported on the inner diameter so when the CIP cup is in place, the CIP feeds up through the bell into a channel 80 formed between the smaller diameter of the flange of the can seal 18 and the side wall inner diameter of the bell.

The valve body is ported to the CIP tube (double button style) or out the back side to a connection (such as ⅛ NPT) for the return hose for the single button valve. In this embodiment, there is constant flow through the double button style valve during CIP. The CIP porting is such that it is only useable when the CIP cup is installed. When the valve is opened, the CIP solution flows through the valve into the bell and out through passageway 90 to outlet 98 to a CIP reservoir, where it is reheated and sent back to the filler, thus eliminating the need for a CIP button. The elimination of the CIP button is less costly for manufacturing and maintenance.

The bell is ported on the inner diameter so when the CIP cup is in place the CIP feeds up through the bell into a channel formed between the smaller diameter of the flange of the container seal and the side wall inner diameter of the bell. The housing passageway ports to the CIP tube 900 (double button style) or out the back side to a ⅛ NPT connection for the return hose for the single button valve. There is constant flow through the double button style valve during CIP. For the double button style valve, the CIP tube ports the CIP solution back through the drilled porting in the chamber but does not require a CIP button.

The present invention swirl fill nozzle creates a more uniform laminar flow during the fill. The swirl counteracts the centrifugal force on the product in the can, keeping the product on a more level plane while filling. The present invention provides a gentler filling that allows the product to be run at a warmer temperature than that of standard filling valves. This results in significant savings on refrigeration and the cost of re-warming the product prior to packaging.

In an embodiment, the method of the present invention can fill liquid at a warmer temperature. The industry standard is to run a filler from 36-38° F. Diet beverages or products that foam easily have to be run at slower speeds to prevent under filling.

The present invention is unique in that the introduction of the product to the container in a “swirl” pattern during filling allows filling at warmer temperatures due to the decrease in foaming. Product is typically mixed from a syrup and water prior to introduction into the container. The temperature of the product results as a combination of the initial temperature of the syrup and the initial temperature of the water. In existing fillers, the product or water is routed through a chiller to reduce the temperature of the product (either by reducing the water temperature lower than 36° F. when the warmer syrup is added, or by chilling the product itself) to about 36° F. Decreasing product temperature decreases foaming. In the present invention, by using the unique swirl fill, product is introduced to a container at temperatures greater than the standard 36° F. In an embodiment, the swirl filling feature allows product temperature at filling in the range from about 36° F. to about 80° F. In an embodiment, product is introduced at a temperature of about 68° F. By way of example, incoming water at a temperature of about 61° F. is mixed with warmer syrup to produce a product temperature of 68° F. At 68° F., the valve fills without refrigeration. In instances where the incoming water is warmer (61-80+° F.), the highest product temperature varies as to the type of product being filled. For example, regular soft drinks can be filled at higher temperatures than diet soft drinks.

In addition, the present invention fills at a product temperature above the dew point. Because the product temperature is above the dew point, containers do not require re-heating after filling. When the incoming water is colder, the containers are cooled to a temperature below the dew point, and condensation forms. so heating is required to avoid condensation. No condensation is formed above the dew point. In an embodiment, the product water is heated to a temperature that is slightly above the dew point. The dew point depends on the ambient temperature and humidity of the facility. If the ambient temperature falls, the dew point is lower, so not as much heating energy is required. One skilled in the art would understand that dew point temperatures will be higher in ambient air having a higher humidity.

Heating the water is less costly than heating the containers. Warmer filling is a better method because the warmer a product is, the less oxygen it can retain. The higher the level of oxygen, the faster oxidation occurs, which eats away the lining in cans and causes the can to leak. Oxygen levels in present beverage cans is typically 1.6-1.8 PPM. Running warmer product lower the oxygen level below 1.5 PPM. Can manufacturers typically provide a 1 year shelf life guarantee provided the oxygen content is under 1.5 PPM.

Other valve manufacturers have tried running product at temperatures of about 55° F. The problem that occurs is that, around a product temperature of about 50° F., the valves fill short. Ball cage shims have to be removed to get the fill weights back into specifications, expending man hours and lost production time. Typically, filling with warmer products produces bubbles during the fill. Using the method of the present invention, the fill weight does not change even at temperatures greater than the standard 36° F. Fill weight is consistent using the present invention filling at a product temperature from about 36° F. to about 80° F. In an embodiment, fill weight does not change when the product is provided at a temperature of 68° F. because of the unique swirl design that greatly reduces bubbles in the product.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. Additional features of the invention will become apparent to those skilled in the art upon consideration of the description. Modifications may be made without departing from the spirit and scope of the invention.

I claim:

1. A filling valve for filling a container with a fluid comprising:
a valve body having a chamber;
a nozzle releaseably attached to the chamber and in fluid communication with the chamber, the nozzle comprising a plurality of ports angled and oriented to direct fluid flowing from the chamber through the ports and into the container, the ports causing the liquid to i) contact the container at a first point of contact at a side wall of the container, and ii) swirl as the liquid fills the container;
a riser tube releaseably connected to the chamber at a floor of the chamber, the chamber floor having a substantially flat surface and at least one housing aperture;
a counter pressure seal at an end of the riser tube opposite the chamber floor, the counter pressure seal connected to a spring, the spring absorbing load from the counter pressure seal upon closing of the riser tube;
a substantially flat liquid seal located in the chamber, the liquid seal moveable to cover and uncover the housing apertures allow the flow of fluid from the chamber to the nozzle, the liquid seal centered in the chamber by a centering device;
a container seal operably positioned around a peripheral surface of the nozzle for substantially preventing liquid from flowing into an area about the peripheral surface, the container seal comprising a seal cavity and positioned for sealably engaging the container;
a ball cage releaseably attached to the valve body though an opening in the nozzle, the ball cage attached to the valve body by a male female thread connector, the ball cage comprising a moveable floatable ball and forming a gas passageway from the container to the riser tube; the riser tube comprising a gas passageway from the ball cage to a space above fluid yet to be dispensed into the container; and
a snift valve in gas communication with the nozzle and the container seal, the snift valve actuated to releasing pressurized gas from the seal cavity and the container causing the container seal to deflate and thereby disengage from the top interior walls of the container.

2. The filling valve of claim 1 wherein a length of the ball cage connector is approximately 0.69 inches.

3. The filling valve of claim 2 wherein the connector is shortened by applying at least one shim.

4. The filling valve of claim 3 wherein the connector is shortened to a length of approximately 0.565 inches when multiple shims are added to the connector.

5. The filling valve of claim 1 further comprising a clean-in-place system to direct cleaning solution through the nozzle and into an interior of a bell surrounding the nozzle and ball cage and, upon actuating the snift valve, causes cleaning solution to pass around an inside of the liquid seal.

6. The filling valve of claim 5 wherein a hose directing the cleaning fluid is in fluid communication with the chamber.

7. A method of using the filling valve of claim 1, the method comprising filling a 12 ounce container with a carbonated beverage in 1.74 seconds.

8. A method of using the filling valve of claim 1, the method comprising introducing fluid into the container at a temperature of greater than about 36° F.

9. A method of using the filling valve of claim 1, the method comprising introducing fluid into the container at a temperature of about 68° F.
